(19) United States
(12) Patent Application Publication
(10) Pub. No.: US 2024/0388447 A1
(43) Pub. Date: Nov. 21, 2024

(54) BATTERY WITH MATERIAL ON EXTERIOR OF CASING TO ABSORB MATTER FROM INSIDE BATTERY AND DISLODGE BATTERY FROM ELECTRICAL CONTACT(S)

(71) Applicant: LENOVO (SINGAPORE) PTE. LTD., Singapore (SG)

(72) Inventors: Arnold Weksler, Morrisville, NC (US); Bouziane Yebka, Morrisville, NC (US); John C. Mese, Morrisville, NC (US); Nathan Peterson, Morrisville, NC (US); Russell Speight VanBlon, Morrisville, NC (US); Mark Delaney, Morrisville, NC (US)

(21) Appl. No.: 18/320,509

(22) Filed: May 19, 2023

(51) Int. Cl. H04L 9/32; G06T 17/00

(52) U.S. Cl. CPC H04L 9/3263; G06T 17/00; H04L 9/3247

(57) ABSTRACT

In one aspect, a device includes a processor and storage with instructions executable to access file data usable to render an avatar or other graphical representation in an extended reality presentation, where the avatar is associated with an end-user. The instructions are also executable to access a digital certificate indicating data associated with the avatar to then, based on the file data and the data from the digital certificate, authenticate the file data as being associated with the end-user.

### FIELD

The disclosure below relates to technically inventive, non-routine solutions that are necessarily rooted in computer technology and that produce concrete technical improvements. In particular, the disclosure below relates to authentication of extended reality (XR) avatars using digital certificates.

### BACKGROUND

As recognized herein, virtual interactions in extended reality (XR) environments are becoming more and more commonplace in today's computer-centric world. However, as also recognized herein, often times a person can claim to be anybody they wish in the virtual environment and use a corresponding virtual representation even if the representation appropriates the name and likeness of another person without authorization. This in turn can lead to digital security issues as well as personal harm to the person that is being impersonated in the virtual environment. There are currently no adequate solutions to the foregoing computer-related, technological problem.

### SUMMARY

Accordingly, in one aspect a first device includes at least one processor and storage accessible to the at least one processor. The storage includes instructions executable by the at least one processor to access a digital certificate indicating data associated with a graphical representation of a person and to access file data for the graphical representation. The instructions are also executable to, based on the file data and the data from the digital certificate, authenticate the graphical representation as being associated with the person.

Thus, in one example implementation the graphical representation may be a first graphical representation, the person may be a first person, and the digital certificate may be accessed via receipt of the digital certificate from a second device different from the first device. The second device may be a device facilitating virtual interaction between the first graphical representation and a second graphical representation, where the second graphical representation may be associated with a second person different from the first person. In certain specific examples, the second device may be a client device associated with the second person.

Also in certain example implementations, the graphical representation may be an avatar, and/or the graphical representation may be configured for use in a virtual reality (VR) environment.

In various example embodiments, the digital certificate itself may be an X509 digital certificate.

Still further, if desired the instructions may be executable to, based on the authentication, present on a display an indication that the graphical representation has been authenticated as associated with the person.

Also in some example implementations, the graphical representation may be a first graphical representation, and the person may be a first person. Here the instructions may be executable to, based on the authentication, permit virtual interaction between the first person and a second person, where the virtual interaction may be interaction beyond the exchange of graphical representation file data and digital certificates. The second person may be different from the first person and may be associated with a second graphical representation different from the first graphical representation.

Still further, in some examples the digital certificate may indicate an identifier for the graphical representation and indicate a digital signature associated with an authority that created the digital certificate. The authority may be different from the person, and the digital signature may sign the file data.

In another aspect, a method includes accessing a digital certificate indicating data associated with a graphical representation of a person and accessing file data for the graphical representation. The method also includes, based on the file data and the data from the digital certificate, authenticating the graphical representation as being associated with the person.

In some example implementations, the file data may include graphics data usable to render the graphical representation on a display and the digital certificate may include a digital signature signing the graphics data. Additionally, the graphical representation may be associated with the person and represent the likeness of the person, while the digital signature may be associated with an entity that created the digital certificate. The entity may be different from the person. Thus, in certain examples the method may include accessing the digital certificate by receiving the digital certificate from a client device of the person. In certain specific examples, the digital certificate may be an X509 digital certificate.

In another aspect, at least one computer readable storage medium (CRSM) that is not a transitory signal includes instructions executable by at least one processor to access file data usable to render an avatar in an extended reality (XR) presentation, where the avatar is associated with an end-user. The instructions are also executable to access a digital signature that signs the file data and then to, based on the file data and the digital signature, authenticate the file data as being associated with the end-user.

In certain examples, the instructions may be executable to access the digital signature at least in part by receiving a digital certificate from a client device of the end user, where the digital certificate may indicate the digital signature. Thus, the digital certificate may include the digital signature, an identifier for the avatar, and an identifier of a storage location at which the file data is accessible.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is a schematic of a first user creating an avatar and associated digital certificate consistent with present principles;

FIGS. 4-6 show example graphical user interfaces (GUIs) that may be presented for the first user to create and use the digital certificate consistent with present principles;

FIG. 7 shows an example GUI that may be presented on a second user's display to validate the first user's digital certificate consistent with present principles;

FIG. 8 shows an example GUI that may be presented responsive to the first user's digital certificate being validated consistent with present principles;

FIG. 9 illustrates example logic in example flow chart format that may be executed by a device consistent with present principles;

FIG. 10 shows an example X509 digital certificate extension consistent with present principles; and

FIG. 11 shows an example GUI that may be presented on a display to configure one or more settings of a device or application (“app”) to operate consistent with present principles.

### DETAILED DESCRIPTION

Among other things, the detailed description below discusses methods of using users' photorealistic avatars in X509 certificate extensions. The X509 certificate may be presented to services, apps, and users and used in a collaborative manner. It will allow the service or app to get an authentic avatar and display it to other users during virtual interactions. The X509 certificate may be created by a trusted authority that has the user's identity documents, photos, and biometric data and is able to confirm to the real user's personal identity. The avatar information may then be stored as X509 extensions.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single-or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, solid state drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C #or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

Present principles may employ machine learning models, including deep learning models. Machine learning models use various algorithms trained in ways that include supervised learning, unsupervised learning, semi-supervised learning, reinforcement learning, feature learning, self learning, and other forms of learning. Examples of such algorithms, which can be implemented by computer circuitry, include one or more neural networks, such as a convolutional neural network (CNN), recurrent neural network (RNN) which may be appropriate to learn information from a series of images, and a type of RNN known as a long short-term memory (LSTM) network. Support vector machines (SVM) and Bayesian networks also may be considered to be examples of machine learning models.

As understood herein, performing machine learning involves accessing and then training a model on training data to enable the model to process further data to make predictions. A neural network may include an input layer, an output layer, and multiple hidden layers in between that that are configured and weighted to make inferences about an appropriate output.

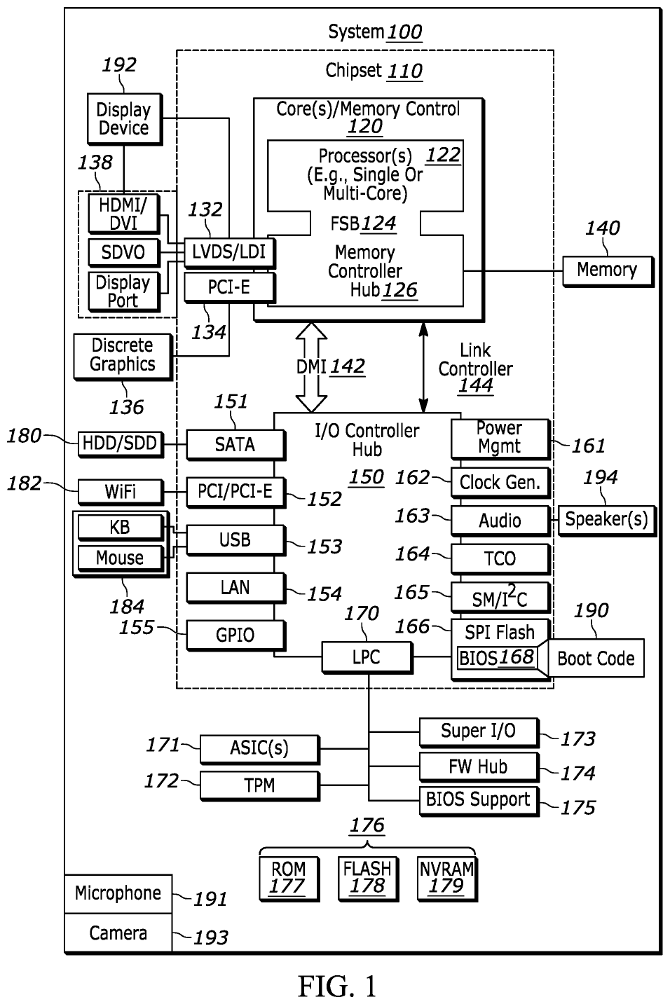

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture,

which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Still further, the system 100 may include an audio receiver/microphone 191 that provides input from the microphone 191 to the processor 122 based on audio that is detected, such as via a user providing audible input to the microphone 191 to speak as part of an XR simulation. The system 100 may also include a camera 193 that gathers one or more images and provides the images and related input to the processor 122. The camera 193 may be a thermal imaging camera, an infrared (IR) camera, a digital camera such as a webcam, a three-dimensional (3D) camera, and/or a camera otherwise integrated into the system 100 and controllable by the processor 122 to gather still images and/or video. For example, the images/video may be used for eye tracking in XR simulations using cameras 193 facing inward when disposed on a headset, and for location tracking for XR simulations when cameras 193 face outward away from the headset.

Additionally, though not shown for simplicity, in some embodiments the system 100 may include a gyroscope that senses and/or measures the orientation of the system 100 and provides related input to the processor 122, an accelerometer that senses acceleration and/or movement of the system 100 and provides related input to the processor 122, and/or a magnetometer that senses and/or measures directional movement of the system 100 and provides related input to the processor 122. Also, the system 100 may include a global positioning system (GPS) transceiver that is configured to communicate with satellites to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

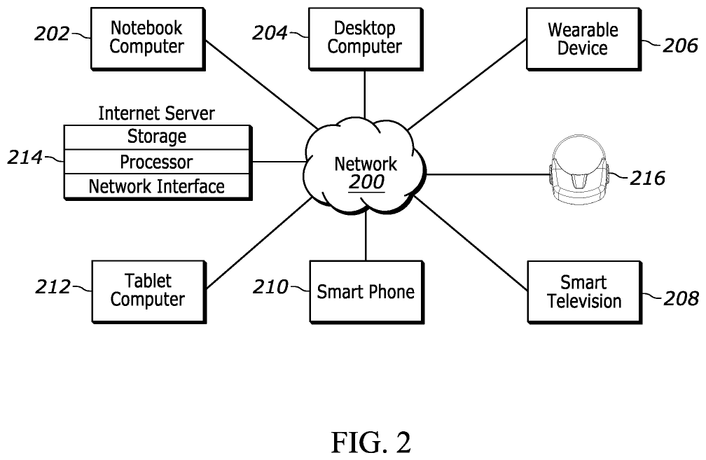

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, an XR headset 216, a server 214 such as an Internet server that may provide cloud storage accessible to the devices 202-212, 216. It is to be understood that the devices 202-216 may be configured to communicate with each other over the network 200 to undertake present principles.

Describing the headset 216 in more detail, note that it may include a non-transparent or transparent “heads up” display. The display may have discrete left and right eye pieces for presentation of stereoscopic images and/or for presentation of 3D virtual images/objects using augmented reality (AR) software, virtual reality (VR) software, mixed reality (MR), and/or another type of XR software consistent with present principles. In various examples, the headset 216 may be a head-circumscribing XR headset to facilitate AR, VR, and/or MR virtual interactions. Additionally or alternatively, the headset 216 may be established by computerized smart glasses or another type of XR headset that presents 3D virtual objects/content consistent with present principles. However, also note that XR simulations that show avatars consistent with present principles may be presented on other display/device types as well, such as smartphones and tablet computers.

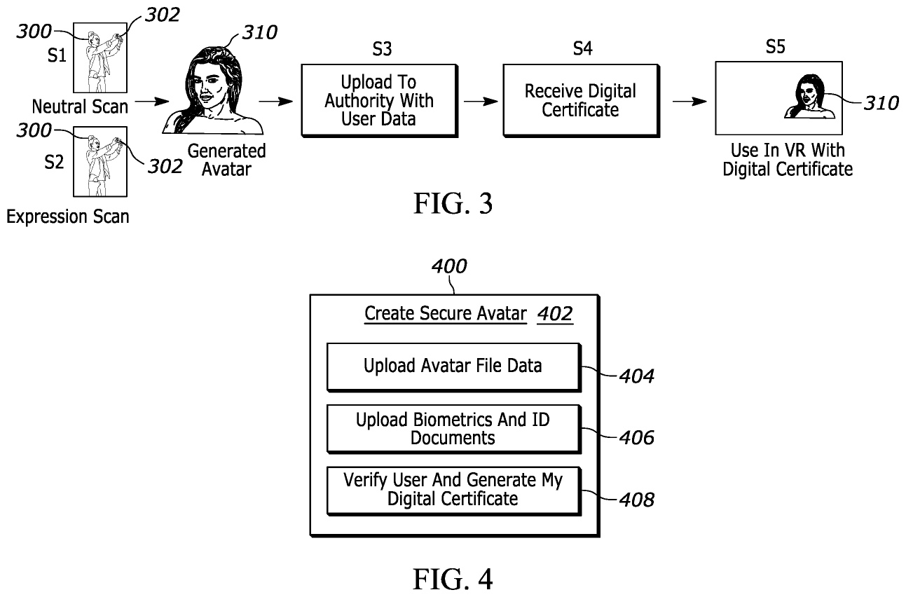

Now in reference to FIG. 3, it shows an example schematic of a real-life end-user 300 creating a digital avatar for use in a virtual world such as the metaverse or another type of AR/VR/MR simulation. At step S1 the user 300 may use one of her cameras on her smartphone 302 to take one or more pictures of her face while she exhibits a neutral facial expression. Then at step S2 the user 300 may use the camera(s) to take more or more pictures of her face while she exhibits facial expressions such as smiling and frowning. Then by itself or in conjunction with a remotely-located server, the smartphone 302 may use the images from the camera to generate a digital three dimensional (3D) model of the user's face that may then be used as a photorealistic avatar 310 for the user 300 to ultimately use the avatar 310 in one or more different XR simulations/virtual worlds. Various types of software may therefore be executed by the phone 302 to generate the photorealistic avatar 310, such as FaceBuilder, Blender, FaceGen, Adobe, Photo Crop to Avatar, PetaPixel, etc.

Still in reference to the schematic of FIG. 3, after the avatar 310 has been created and stored as avatar file data, the avatar file data may be uploaded at step S3 to a server of a certificate authority that issues digital certificates consistent with present principles. User data such as biometrics, driver's license information, avatar identity (ID), avatar storage location, and other types of data described further below may also be uploaded to the server at step S3. The central authority itself may be, for example, the ITU Telecommunication Standardization Sector (ITU-T), though other suitable authorities may also be used. The digital certificates that are issued may be X509 certificates using the ITU standard, though other types of digital certificates may also be used like those in RFC format.

Once the desired information is uploaded at step S3, at step S4 the smartphone 302 may receive back a digital certificate that encapsulates/indicates some or all of the user's information. The digital certificate may also include a digital signature from the certificate authority, with the digital signature signing the file data of the user's avatar 310 and/or signing the digital certificate itself. The file data may therefore be signed with the certificate authority's private key so that it may be validated later by a client device or server using the authority's public key.

Concluding the description of FIG. 3, note that after step S4, at step S5 the user 300 may use the smartphone 302 and/or a coordinating server to load the avatar/file data and digital certificate into a virtual VR simulation and then control the avatar 310 within the VR simulation. Also at step S5, the server/smartphone 302 may present the user's certificate to other users that are also participating in the simulation and that might even encounter the user's avatar 310 within the simulation. The client devices of the other users that are presented with the digital certificate may then authenticate the avatar 310 as being associated with the user 300 themselves.

FIGS. 4-6 further illustrate various parts of the process that the user 300 may go through as described above. FIG. 4 thus shows an example graphical user interface (GUI) 400 that may be presented on the display of the smartphone 302 for the user 300 to upload data to the certificate authority after creating an avatar (and/or creating other type of graphical representation for use in an XR simulation). The GUI 400 may include a prompt 402 for the user 300 to create a secure avatar by generating a digital certificate for the avatar that attests to the avatar's authenticity as being associated with the real-life person 300 (e.g., with the person themselves also being authenticated using a driver's license, biometric data, etc. as set forth further below).

Accordingly, the GUI 400 may include a selector 404 that may be selectable to launch a file browser from which the avatar file data may be selected from storage and then uploaded to the certificate authority. The GUI 400 may also include a selector 406 that may be selectable to launch another file browser or other process by which other user data such as biometric data and government-issued ID document data may be uploaded. For example, the certificate authority may use the user's smartphone's camera to scan the user's face for facial biometric data such as face feature points, iris pattern, and earlobe pattern. The user 300 may also hold up to the camera her government-issued driver's license, passport, or other ID document that has a photo of her face on it for the certificate authority to then match biometric data from the ID photo itself to the biometric data just acquired from the user's camera. The certificate authority may also use the ID document to validate its information by comparing the ID document information to ID information provided by the government agency itself that issued the ID document to thus authenticate/verify the user 300 herself. In some examples, this back and forth with the government agency may be done using a zero-knowledge proof algorithm. Then after the data above has been uploaded, selector 408 may be selected to command/authorize the certificate authority to perform/complete this verification process and then issue a digital certificate for the user 300/avatar 310.

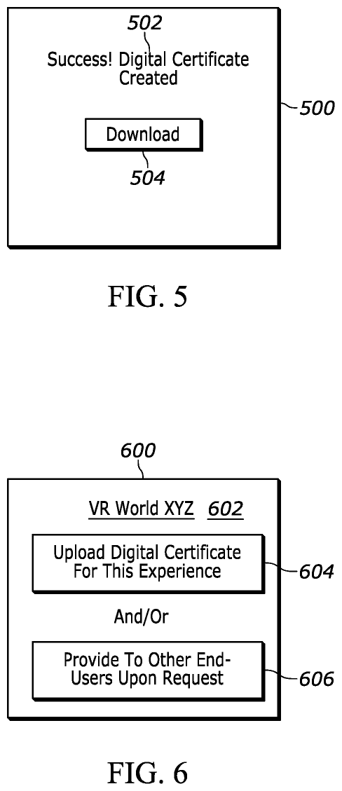

FIG. 5 shows an example GUI 500 that may then be presented on the display of the user's smartphone 302 responsive to the digital certificate being created. Prompt 502 indicates that the digital certificate has been successfully created and is available for download. The user 300 may then download the digital certificate itself by selecting the selector 504, with the digital certificate being downloaded to storage on the smartphone 302 and/or storage in the user's cloud-based remote server storage.

Then when the user 300 goes to participate in an XR simulation such as a metaverse simulation or VR video game, the GUI 600 of FIG. 6 may be presented before the simulation is loaded and executed. Additionally or alternatively, the GUI 600 may be presented during simulation execution responsive to another person that the user 300 encounters within the simulation requesting the user's digital certificate to authenticate the user's avatar 310 as actually being associated with the user 300 themselves (e.g., rather than someone faking the user's likeness within the simulation via the avatar 310).

As shown in FIG. 6, the GUI 600 may include an indication 602 of the name of the simulation. The GUI 600 may also include a selector 604 that may be selectable to command the user's smartphone 302 to upload the digital certificate from wherever it was stored so that it may be loaded into the platform or simulation itself along with the user's avatar file data for the simulation, simulation host/platform, and/or other entity to then authenticate the avatar 310 using the digital certificate. Thus, avatar authentication may take place at the outset while the simulation is being loaded. Then, assuming the avatar 310 has been authenticated via the digital certificate, the user's avatar 310 may be assigned a universal “authenticated” or “verified” status flag within the simulation so that other end-users may be notified accordingly.

As also shown in FIG. 6, the user may additionally or alternatively select selector 606 to provide the digital certificate to other individual end-users on an ad hoc basis for validation when requested by those other end-users (e.g., rather than having the simulation platform itself validate the certificate and universally indicate the user 300 as authenticated). Thus, if the GUI 600 were presented prior to loading the simulation, selection of the selector 606 may configure the simulation to provide the user's digital certificate to others automatically in the background upon request by others (e.g., without the user receiving a pop-up or other type of notification while within the simulation that the certificate is being requested/provided). And if the GUI 600 were presented during simulation execution responsive to another end-user requesting the user's digital certificate when encountering the avatar 310, the selector 606 may be selectable to transmit the user's digital certificate to the requesting user's device for validation by the requesting user's device.

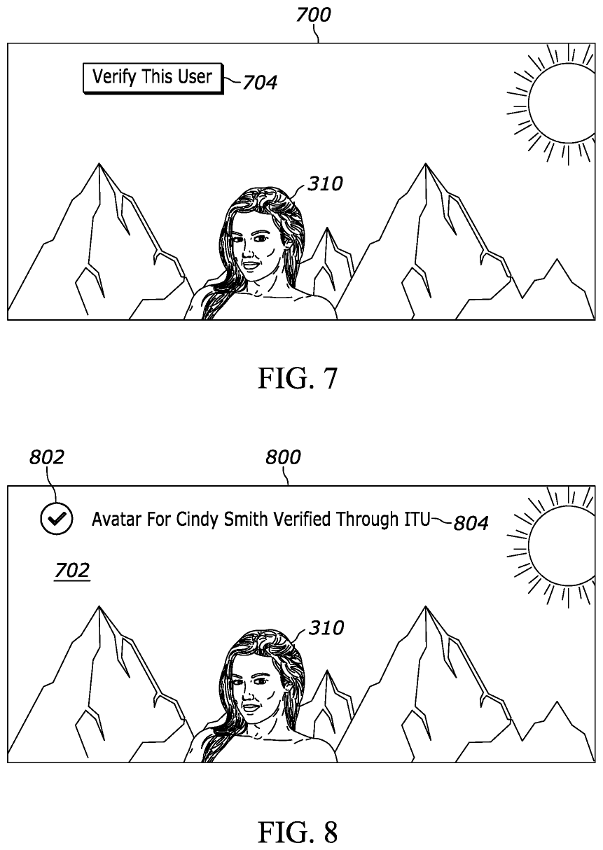

FIG. 7 therefore shows an example GUI 700 that may be presented on the display of the requesting user's client device. Virtual content 702 is shown that may be presented as part of the simulation itself, with the virtual content 702 including mountains and the sun as shown. The avatar 310 of the user 300 is also presented to the requesting user. The requesting user may then use a voice command, a touch command, or another type of command to select selector 704, which in turn may generate an electronic request for the digital certificate itself that is associated with the avatar 310 that has been encountered within the simulation. The request may thus be transmitted to the user's smartphone 302 and/or the hosting platform itself for the phone/platform to then transmit back the digital certificate for validation by the other end-user's device/system.

Then once validated, the GUI 800 of FIG. 8 may be presented on the display of the requesting user's device. As shown, the virtual content 702 is still presented but in place of the selector 704 are graphical indications that the avatar 310 for the user 300 (named “Cindy Smith” in this example) has been verified through the appropriate certificate authority using the digital certificate. The certificate authority is ITU in this example but might be another authority as well. In any case, the graphical indications that are presented may include a green check mark 802 and text 804 indicating the verification as shown.

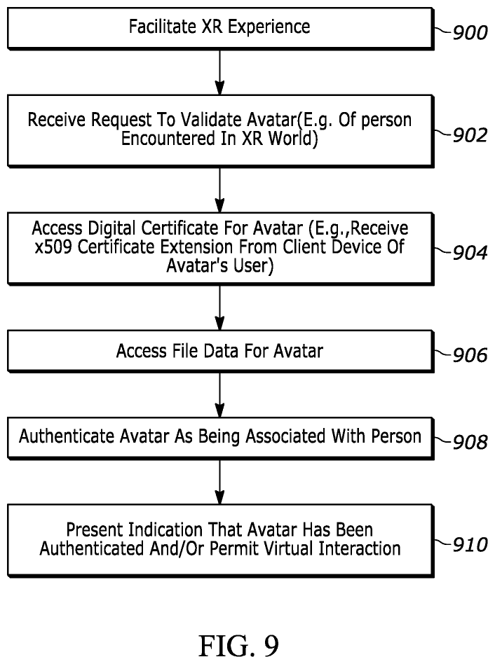

Turning now to FIG. 9, example logic is shown that may be executed by one or more devices such as a client device and/or a remotely-located server in any appropriate combination consistent with present principles. Note that while the logic of FIG. 9 is shown in flow chart format, other suitable logic may also be used. The logic of FIG. 9 may be executed for a first end-user and/or simulation platform (e.g., server-based) to authenticate that a second end-user's photorealistic avatar is in fact actually associated with and controlled by the second end-user themselves. The first end-user may then know when interacting with the second end-user's avatar in an XR simulation (via their own respective avatar) that the first end-user is in fact interacting with an authenticated user whose actual likeness is represented by the avatar, thus enhancing the digital security of the XR simulation and hosting platform itself.

Beginning at block 900, the device may facilitate the XR simulation by loading and/or executing the simulation. In some examples, this may include loading the second end-user's avatar into the simulation from a storage location indicated in the avatar's digital certificate as already provided by the second end-user. Additionally or alternatively, the second end-user may upload the avatar file data themselves (possibly without providing the digital certificate first).

The logic may then proceed to block 902 where the device may receive a request from the platform, simulation, and/or first end-user to validate the second end-user's avatar. For example, the request may be a verbal request for validation from the first end-user, where the first end-user says “validate” or “authenticate” while looking at the second end-user's avatar within the simulation/virtual world (e.g., as determined through eye tracking). As another example, the request from the first end-user may be received via selection of a selector like the selector 704 described above, with the selector being presented on the first end-user's display responsive to the second-end user's avatar coming within the first end-user's current simulation field of view.

Responsive to receiving the request, the logic of FIG. 9 may then proceed to block 904 where the device may access the second end-user's digital certificate that indicates data associated with the avatar of the second end-user. For example, the digital certificate may be an X509 digital certificate extension and may be received from the client device of the second-end user based on a request received from the first end-user's device. The digital certificate may also be accessed from another location as well, such as from a storage location on a server of the simulation's hosting platform, in cloud storage of the first end-user, etc. The storage location might be reported by the second end-user's device upon request, or might be accessible from the second end-user's simulation platform profile or other source, for example.

From block 904 the logic may proceed to block 906. At block 906 the device may access file data for the second end-user's avatar, including graphics data usable to render the avatar on a display/within the simulation itself. The graphics data may therefore include 3D modeling data and feature point data, image data, texture data, color data, etc. for visually rendering the avatar. The graphics data may be received from the client device of the second-end user based on the request from the first end-user and/or based on the first end-user uploading the data themselves. The graphics data may additionally or alternatively be accessed from a storage location as set forth above.

The logic of FIG. 9 may then proceed from block 906 to block 908 where, based on the file data and the data from the digital certificate itself, the device may authenticate the second end-user's avatar as being associated with the second end-user themselves. The device may do so by validating the digital certificate, including validating the digital signature in it that has signed the avatar file data itself to thus verify that the file data as also currently loaded/used to render the second end-user's avatar within the simulation has in fact been tied to the second end-user's verified real-world identity by the certificate authority (e.g., as also indicated in the digital certificate). Other data that may be indicated in the digital certificate and validated for even greater security include an avatar signature, avatar zero-knowledge proofs, access keys to the avatar file data/identity image files, a real-life photograph of the associated user themselves, and zero-knowledge proofs related to the user's biometrics such as facial feature points, ear lobe signature, iris signature, and/or fingerprint signature.

From block 908 the logic may then proceed to block 910. At block 910 the device may take one or more other actions. For example, based on the authentication at block 910 the device may present one or more indications that the second end-user's avatar has been authenticated as associated with the second end-user. These indications might include the elements 802 and 804 described above, for example.

Additionally or alternatively, based on the authentication at block 910 the device may permit virtual interaction between the first end-user and the second end-user within the simulation by permitting their respective avatars to interact in the virtual environment and allowing the two users to themselves exchange other data such as voice streams for bidirectional audio communication. Other types of interactions (beyond the exchange of avatar file data and digital certificates) may also be permitted. But it is to be further understood that in some examples, virtual “physical” interactions between the avatars as well as telephonic or other audio communication between the two end users themselves may only be enabled between authenticated users to further enhance digital security.

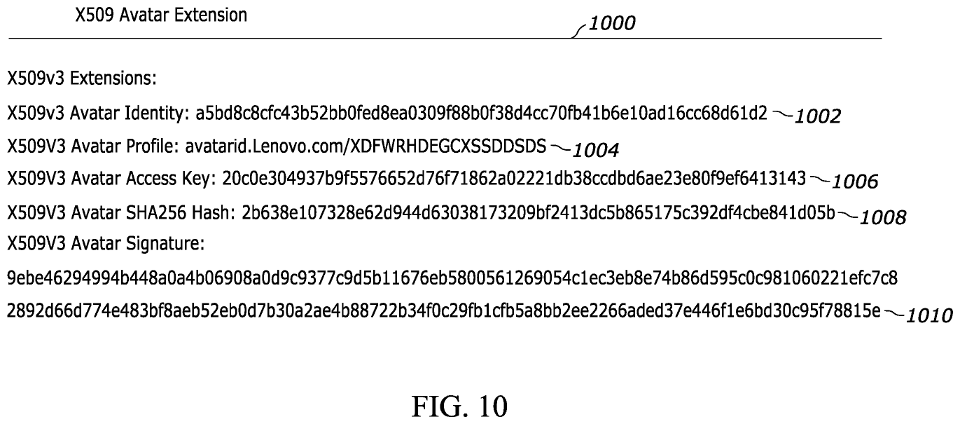

Now in reference to FIG. 10, an example digital certificate 1000 is shown, which in this case is an X509 avatar certificate extension. As shown, example extensions/data that may be included are avatar ID 1002, a storage location 1004 at which the avatar profile and/or file data may be accessed, and an avatar access key 1006 as may be required in some examples to access an encrypted or password-protected version of the profile/file data itself at the storage location 1004. A checksum/hash 1008 of the profile/file data may also be included for validation purposes, along with a digital signature 1010 signed by the digital certificate's issuing certificate authority. Again note that the signature 1010 may sign the digital certificate and/or avatar file data itself (including graphics/rendering data).

Note that other data may also be included in the digital certificate depending on implementation. For example, zero-knowledge proofs may be included for validation that are related to the user's biometrics (such as ear lobe signature, iris signature, and/or fingerprint signature) for the associated user to be validated in real time through the zero-knowledge proofs during simulation execution using real time images of their lobe/iris/fingerprint as captured by their client device during their participation in the virtual simulation. Driver's license or other government ID information may also be included in the digital certificate for validation against a driver's license or other ID presented by the associated user themselves to a camera on their device before or during participation in the virtual simulation. These techniques may provide an added layer of security in case someone else gains control of the user's device (and hence has access to the user's legitimate digital certificate as might be stored thereon).

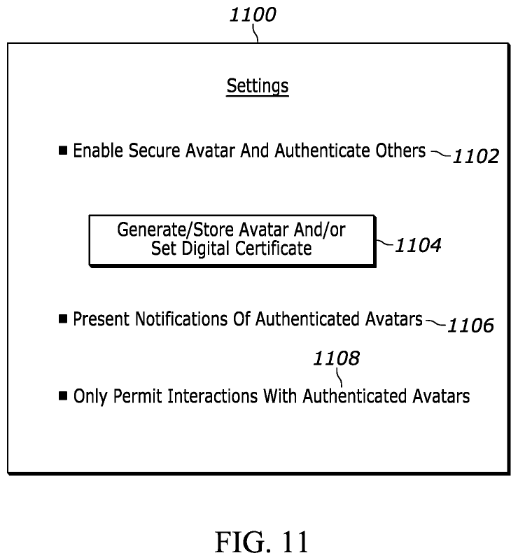

Continuing the detailed description in reference to FIG. 11, it shows another example GUI 1100 that may be presented on the display of a client device configured to operate consistent with present principles. The GUI 1100 may be presented to configure one or more settings of the client device to undertake present principles and may be presented based on the user navigating a device or app menu, for example. The example options described below may be selected via touch, cursor, or other input directed to the associated check box per this example.

As shown in FIG. 11, the GUI 1100 may include a first option 1102 that may be selectable a single time to set/configure the device to in the future create digital certificates as described herein. The option 1102 may additionally or alternatively be selectable to set/configure the device to in the future provide digital certificates for the device's user/avatar when loading a given XR simulation and/or upon request from another XR simulation user. The option 1102 may also additionally or alternatively be selectable a single time to set/configure the device to in the future validate the digital certificates of others' avatars during XR simulations consistent with present principles.

As also shown in FIG. 11, the GUI 1100 may include a selector 1104 that maybe selectable to initiate a process as set forth above for generating and storing an avatar for the user and then acquiring a digital certificate for it. Thus, selection of the selector 1104 might initiate the process described above in reference to FIG. 3, for example.

The GUI 1100 may also include an option 1106 in some examples. The option 1106 may be selectable to set/configure the client device to present notifications within XR simulations of other avatars that the user encounters that have been authenticated. Also if desired, the GUI 1100 may include an option 1108 that may be selectable to set or configure the device/user's profile to only allow the user to virtually interact within XR simulations with the avatars of others who have already been authenticated via their own respective digital certificates consistent with present principles.

Moving on from FIG. 11, note more generally as described herein that the avatar or other graphical representation of a user (e.g., video game character) for use in an XR simulation may represent the likeness of the associated person themselves. So in one specific example, a user may submit avatar file data to a certificate authority along with an image of an ID document like a driver's license or ID card. The certificate authority might then verify that the ID document as presented to it match records available from a reliable third-party source such as the issuing government agency itself. The certificate authority may then also use an artificial intelligence-based model such as a trained convolutional neural network to determine whether the avatar's face matches that of the real-life user to at least within a threshold level of confidence. The threshold level of confidence may be high enough to ensure the avatar exhibits the likeness of the person themselves but still low enough to account for pixelation and other cross-domain issues that might arise when comparing a photograph to a computer-generated avatar image. As such, the threshold level of confidence may be in the range of 65-70% in certain non-limiting examples. Then responsive to the user's face matching the avatar's face to the threshold level of confidence, the device/certificate authority may include an additional extension in the digital certificate itself, possibly signed via the authority's digital signature, that includes a certification that the avatar image matches the likeness of its real-life user (as themselves authenticated through the user's ID).

Also consistent with present principles, note that X509 extensions or whatever other type of digital certificate is being used may be supported by an immutable, privacy-protecting, avatar identity system in certain non-limiting implementations. The system may be associated with the simulation platform itself and may store large files related to the avatar (e.g., avatar file data). The system may still be publicly accessible and/or may be a global file system with encryption. The system might even be broken up into two services—one to generate the digital certificate itself and one to verify things later as a certificate authority when the digital certificate is presented by/to someone else.

It may now be appreciated that present principles provide for an improved computer-based user interface that increases the functionality and digital security of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A first device, comprising:
at least one processor; and
storage accessible to the at least one processor and comprising instructions executable by the at least one processor to:
access a digital certificate indicating data associated with a graphical representation of a person;
access file data for the graphical representation; and
based on the file data and the data from the digital certificate, authenticate the graphical representation as being associated with the person.

2. The first device of claim 1, wherein the graphical representation is a first graphical representation, wherein the person is a first person, and wherein the digital certificate is accessed via receipt of the digital certificate from a second device different from the first device, the second device being a device facilitating virtual interaction between the first graphical representation and a second graphical representation, the second graphical representation being associated with a second person different from the first person.

3. The first device of claim 2, wherein the second device is a client device associated with the second person.

4. The first device of claim 1, wherein the graphical representation is an avatar.

5. The first device of claim 1, wherein the graphical representation is configured for use in a virtual reality (VR) environment.

6. The first device of claim 1, wherein the digital certificate is an X509 digital certificate.

7. The first device of claim 1, wherein the instructions are executable to:
based on the authentication, present on a display an indication that the graphical representation has been authenticated as associated with the person.

8. The first device of claim 1, wherein the graphical representation is a first graphical representation, wherein the person is a first person, and wherein the instructions are executable to:
based on the authentication, permit virtual interaction between the first person and a second person, the virtual interaction being interaction beyond the exchange of graphical representation file data and digital certificates, the second person being different from the first person and being associated with a second graphical representation different from the first graphical representation.

9. Then first device of claim 1, wherein the digital certificate indicates an identifier for the graphical representation and indicates a digital signature associated with an authority that created the digital certificate, the authority being different from the person.

10. The first device of claim 9, wherein the digital signature signs the file data.

11. A method, comprising:
accessing a digital certificate indicating data associated with a graphical representation of a person;
accessing file data for the graphical representation; and
based on the file data and the data from the digital certificate, authenticating the graphical representation as being associated with the person.

12. The method of claim 11, wherein the file data comprises graphics data usable to render the graphical representation on a display.

13. The method of claim 12, wherein the digital certificate comprises a digital signature signing the graphics data.

14. The method of claim 13, wherein the graphical representation is associated with the person, and wherein the digital signature is associated with an entity that created the digital certificate, the entity being different from the person.

15. The method of claim 14, comprising:
accessing the digital certificate by receiving the digital certificate from a client device of the person.

16. The method of claim 15, wherein the graphical representation represents the likeness of the person.

17. The method of claim 11, wherein the digital certificate is an X509 digital certificate.

18. At least one computer readable storage medium (CRSM) that is not a transitory signal, the at least one CRSM comprising instructions executable by at least one processor to:
access file data usable to render an avatar in an extended reality (XR) presentation, the avatar associated with an end-user;
access a digital signature that signs the file data; and
based on the file data and the digital signature, authenticate the file data as being associated with the end-user.

19. The at least one CRSM of claim 18, wherein the instructions are executable to:
access the digital signature at least in part by receiving a digital certificate from a client device of the end-user, the digital certificate indicating the digital signature.

20. The at least one CRSM of claim 19, wherein the digital certificate comprises: the digital signature, an identifier for the avatar, and an identifier of a storage location at which the file data is accessible.
